(19) United States
(12) Patent Application Publication
(10) Pub. No.: US 2014/0129369 A1
(43) Pub. Date: May 8, 2014

(54) SYSTEM FOR CUSTOMIZING INFORMATION IN AN E-PROCUREMENT PROCESS

(71) Applicants: PRASAD GUPTE, MUMBAI (IN); BIKASH MOHANTY, MUMBAI (IN)

(72) Inventors: PRASAD GUPTE, MUMBAI (IN); BIKASH MOHANTY, MUMBAI (IN)

(21) Appl. No.: 13/740,018

(22) Filed: Jan. 11, 2013

(30) Foreign Application Priority Data
Nov. 8, 2012 (IN) 3248/MUM/2012

(51) Int. Cl. G06Q 30/06

(52) U.S. Cl. CPC G06Q 30/0621
USPC 705/26.5

(57) ABSTRACT

A system for customizing information in e-procurement process, including a selecting system adapted for selecting item(s) to be procured from catalog database, which further includes a suggesting system adapted for suggesting if the item being selected by the user is a custom made item and providing a link or button for customization for the custom made item, and a customization system adapted for customizing information in the e-procurement process by generating a category-specific web-based form based at least upon one or more pre-configured decision rules. The system helps to order custom required goods, which aids in providing custom requirements and specifications through web-based forms at the time of ordering and thus avoids mentioning of custom requirements each and every time when the item is ordered.

### CROSS-REFERENCE TO RELATED APPLICATION

The instant application claims priority to Indian Patent Application Serial No. 3248/MUM/2012, filed Nov. 8, 2012, pending, the entire specification of which is expressly incorporated herein by reference.

### FIELD OF THE INVENTION

The present invention generally relates to electronic procurement, and more particularly to a system for customizing information in e-procurement process.

### BACKGROUND OF THE INVENTION

While procuring goods electronically, regardless of the descriptive information of the items present in the catalog, additional information is required by the buyer/supplier so as to deliver the selected items, such as buyer's name, e-mail ID, phone number, etc. At present, few systems are available to provide such additional information along with the items to be procured to the supplier, but this information is stored in an unstructured and very generic description fields.

Accordingly, there exists a need for new and improved electronic procurement systems and methods that overcome at least one of the aforementioned problems.

### SUMMARY OF THE INVENTION

In accordance with the general teachings of the present invention, a system is provided for customization of information in e-procurement processes by means of generating web-based forms. These web-based forms are category specific and contain fields, out of which a few fields can be altered by the user and a few cannot be altered, and even if altered, requires approval before placing an order.

In accordance with one embodiment of the present invention, a system is provided for customizing information in an e-procurement process. The system may include:

a selecting system adapted for selecting item(s) to be procured from a catalog database, for example, an online catalog database, that may further include a suggesting system adapted for suggesting if the item being selected by the user is a custom made item and providing a link or button for customization for the custom made item; and

a customization system adapted for customizing information in an e-procurement process by generating category-specific web-based form(s) based at least upon one or more pre-configured decision rule(s).

These web-based forms, when stored in the server system of the buyer/supplier, may be re-used with multiple items and also may be selected to be used with the items belonging to the same category. The web-based form(s) may be adapted for capturing additional information related to the particular item being procured which may be, but not limited to, the buyer's name, buyer's designation, phone number, e-mail ID, and/or other details. The web-based forms may contain a plurality of fields meant for capturing additional information related to the item(s) to be procured, wherein a plurality of fields may be kept locked (i.e., not allowing user to alter) and others may be altered, for example, requiring approval for alteration before placing an order.

The system may be further adapted for validation of entered information in the web-based form, storage of validated information, and/or transmission of the information along with a purchase order (PO) to the supplier.

The system of present invention may also guide the buyer during the procurement process by suggesting the source of procurement based on the user provided information on the web-based form. It may further guide the buyer during the procurement process by suggesting the supplier from which a particular item can be procured.

An object of the present invention is to provide a system for customizing information in an e-procurement process.

Another object of the present invention is to provide a system that aids in providing custom requirements and specifications of item(s) to the buyer/supplier while procuring an item(s) in an e-procurement process.

Yet another object of the present invention is to provide a system that aids in providing custom requirements and specifications of item(s) through web-based form(s) to the buyer/supplier while procuring an item(s) in an e-procurement process.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWING

The invention will now be described in relation to the accompanying drawings in which:

FIG. 1 illustrates a schematic of the work flow of a system for customizing information in an e-procurement process; and

FIG. 2 illustrates a schematic of the web-based form generated in the system showing fields in the web-based form.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

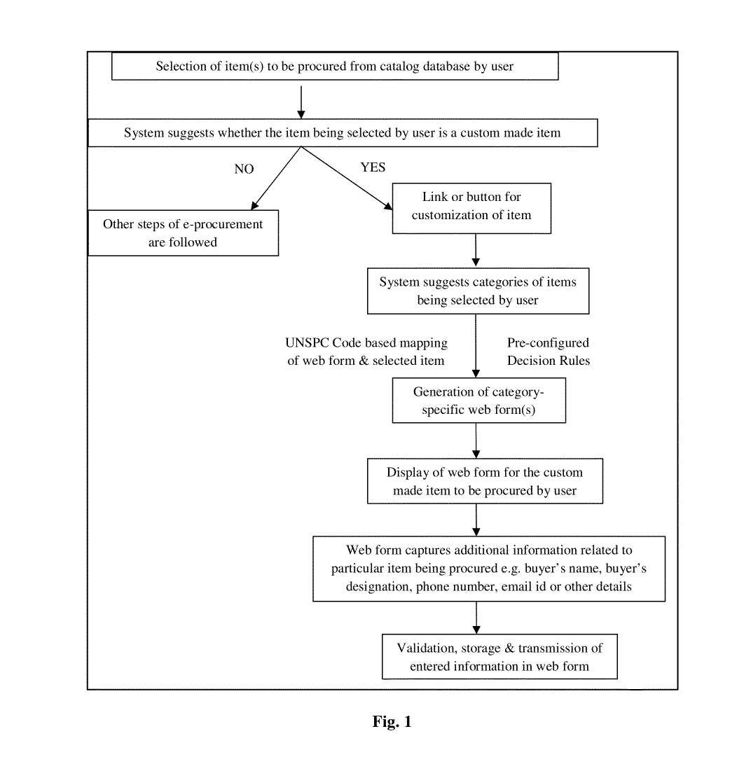

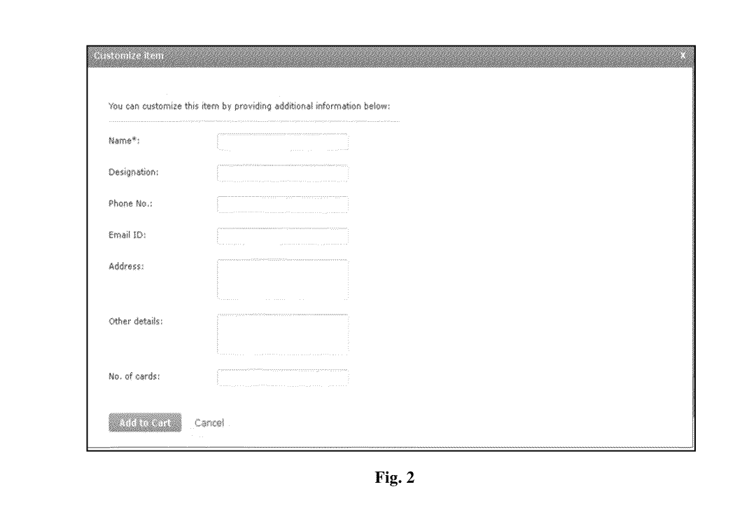

Referring to FIGS. 1-2, and according to an exemplary embodiment, a system is shown for customizing information in e-procurement process.

The system may include:

a selecting system adapted for selecting item(s) to be procured from a catalog database, for example, an online catalog database; and

a customization system adapted for customizing information in e-procurement process.

According to another exemplary embodiment, the selecting system may further include a suggesting system that aids in suggesting if the item being selected by the user is a custom made item, and providing a link or button for customization for the custom made item. The suggesting system may be further adapted for suggesting categories of items being selected by the user.

According to yet another exemplary embodiment, the customization system may be adapted for customizing information in an e-procurement process by generating category-specific web-based form(s) based at least upon one or more pre-configured decision rule(s). These decision rules may include mapping of the category of the item to be procured by the user and web-based forms based on the United Nations Standard Products and Services Code (“UNSPC”) Code. The decision rules may further include category-based selection of web-based forms, e.g., an item is selected from the catalog that is to be ordered from the United States of America, but the same item can also be ordered from India or China, so different web-based forms may be generated based on regions as custom made requirements would be different for different countries/regions so the system will suggest to select categories which can be regions or vendors. Upon selection of the category, specific web-based forms may be generated based on the pre-configured decision rules.

According to still another exemplary embodiment, the web form(s) is stored in the server system of buyer/ supplier or within catalog. When the web form(s) is stored in the server system of buyer/ supplier, the web form(s) can be re-used with multiple items. Also, the web form(s) can be selected to be used with the items belonging to same category. While loading the item(s) in the catalog, the item(s) can be linked to web form(s) stored in the server system for a particular item or category.

According to still another exemplary embodiment, these web-based forms may be adapted for capturing additional information related to the particular item being procured that may be, but not limited to, buyer's name, buyer's designation, phone number, e-mail ID, and/or other details.

The system may be adapted for displaying the web-based forms for the custom made item to be procured by the user and the web-based forms may contain a plurality of fields meant for capturing additional information related to the item(s) to be procured. While the plurality of fields of the web-based forms may be kept locked (e.g., not allowing the user to alter them) and a plurality of the fields of the web-based forms may be altered (e.g., requiring approval for alteration before placing order).

The system may be further adapted for the validation of entered information in the web-based forms, storage of the validated information, and transmission of the information along with a purchase order (PO) to the supplier.

The system for customizing information in e-procurement process may help to order custom required goods. The system may aid in providing custom requirements and specifications through the web-based forms at the time of ordering and thus avoid mentioning of custom requirements each and every time when the item is ordered.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for customizing information in e-procurement process, the system comprising:
a selecting system adapted for selecting items to be procured from a catalog database; and
a customization system adapted for customizing information in the e-procurement process.

2. The system as claimed in claim 1, wherein the selecting system includes a suggesting system that aids in suggesting if the item being selected by user is a custom made item, and providing a link or button for customization for the custom made item.

3. The system as claimed in claim 2, wherein the suggesting system is adapted for suggesting categories of items being selected by the user.

4. The system as claimed in claim 1, wherein the customization system is adapted for customizing information in the e-procurement process by generating a category-specific web-based form based at least upon one or more pre-configured decision rules.

5. The system as claimed in claim 4, wherein the decision rules include mapping of the category of the item to be procured by the user and the web-based form based on the UNSPC Code.

6. The system as claimed in claim 4, wherein the decision rules includes category-based selection of the web-based form.

7. The system as claimed in claim 4, wherein the web-based form is stored in a server system of a buyer/supplier or within a catalog.

8. The system as claimed in claim 7, wherein, for the web-based form stored in the server system of the buyer/supplier, the web-based form can be re-used with multiple items.

9. The system as claimed in claim 7, wherein, for the web-based form stored in the server system of the buyer/supplier, the web-based form can be selected to be used with the items belonging to the same category.

10. The system as claimed in claim 7, wherein the items at the time of loading in the catalog can be linked to the web-based form stored in the server system for a particular item or category.

11. The system as claimed in claim 4, wherein, the web-based form is adapted for capturing additional information related to a particular item being procured that include a buyer's name, buyer's designation, phone number, and/or e-mail ID.

12. The system as claimed in claim 4, wherein the system is adapted for displaying the web-based form for the custom made item to be procured by the user, wherein the web-based form contains a plurality of fields meant for capturing additional information related to the items to be procured.

13. The system as claimed in claim 12, wherein the plurality of fields of the web-based form are kept locked or can be altered.

14. The system as claimed in claim 4, wherein the system is adapted for validation of entered information in the web-based form, storage of validated information, and transmission of the information along with a purchase order to the supplier.

15. A method for customizing information in e-procurement process, comprising:
providing a selection system of items to be procured from a catalog database; and
providing a customization system of information in the e-procurement process.

16. The method as claimed in claim 15, wherein the selection system comprises suggesting if the item being selected by the user is a custom made item and providing a link or button for customization for the custom made item.

17. The method as claimed in claim 16, wherein the suggesting system is adapted for suggesting categories of items being selected by the user.

18. The method as claimed in claim 15, wherein the customization system is adapted for customizing information in the e-procurement process by generating a category-specific web-based form based at least upon one or more pre-configured decision rules.

19. The method as claimed in claim 18, wherein the decision rules include mapping of the category of the item to be procured by the user and the web-based form based on the UNSPC Code.

20. The method as claimed in claim 18, wherein the decision rules further include category based selection of the web-based form.

21. The method as claimed in claim 18, wherein the web-based form is stored in a server system of a buyer/supplier or within a catalog.

22. The method as claimed in claim 21, wherein, for the web-based form stored in the server system of the buyer/supplier, the web-based form can be re-used with multiple items.

23. The method as claimed in claim 21, wherein, for the web-based form stored in the server system of buyer/supplier, the web-based form can be selected to be used with the items belonging to the same category.

24. The method as claimed in claim 15, wherein the items at the time of loading in a catalog can be linked to a web-based form stored in a server system for a particular item or category.

25. The method as claimed in claim 15, wherein a web-based form is adapted for capturing additional information related to a particular item being procured that can include a buyer's name, buyer's designation, phone number, and/or e-mail ID.

26. The method as claimed in claim 15, further comprising providing a system adapted for displaying a web-based form for the custom made item to be procured by the user, wherein the web-based form contains a plurality of fields meant for capturing additional information related to items to be procured.

27. The method as claimed in claim 26, wherein the plurality of fields of the web-based form can be kept locked or can be altered.

28. The method as claimed in claim 15, further comprising providing a system adapted for validation of entered information in a web-based form, storage of validated information, and transmission of the information along with a purchase order to a supplier.
